(19) United States
(12) Patent Application Publication
(10) Pub. No.: US 2018/0156322 A1
(43) Pub. Date: Jun. 7, 2018

(54) BALL SCREW WITH A SUPPORT DEVICE

(71) Applicant: HIWIN TECHNOLOGIES CORP., Taichung City (TW)

(72) Inventors: Szu-Wei YU, Taichung City (TW); Ying-Ju LIN, Taichung City (TW); Chieh-Ping WANG, Taichung City (TW)

(73) Assignee: Hiwin Technologies Corp.

(21) Appl. No.: 15/366,772

(22) Filed: Dec. 1, 2016

(51) Int. Cl. F16H 37/16; F16H 25/22; F16H 19/06

(52) U.S. Cl. CPC F16H 37/16; F16H 19/06; F16H 25/2204

(57) ABSTRACT

A ball screw with a support device includes: a screw; a nut unit movably mounted on the screw; a support device including: a first support seat and a second support seat which are movably mounted on the screw and located at two sides of the nut unit; and a speed control device capable of presetting a speed of the nut unit and the first and second support seats, wherein the speed of the nut unit is V_{NT}, the speed of the first and second support seats is V_{SUP}, and they satisfy the relation: 0<V_{SUP}/V_{NT}<½. When the two ends of the screw are used as a fixing end and a support end, respectively, the ball screw can have an optimized critical rotation speed, which consequently improves the work efficiency of the ball screw.

### BACKGROUND OF THE INVENTION

### Field of the Invention

The present invention relates to a ball screw, and more particularly to a ball screw with a support device.

### Related Prior Art

A motion transmission apparatus used on a machine generally comprises a screw and a nut (which includes the nut and a carrying platform on the nut) movably disposed on the screw. To prevent sagging of the screw, the motion transmission apparatus is usually provided with a support device, so that the nut can move along the same central line, which can reduce abrasion, prevent too high temperature and structure deformation, and also expand the movement range of the nut and ensure machining precision.

As shown in FIGS. 1A and 1B, a ball screw with a support device disclosed in a German patent No. DE 102009005785A1 includes: a screw 11, a rail 12 arranged in parallel to the screw 11, and two support seats 14 which are disposed at two sides of the nut unit 13 and located between the screw 11 and the rail 12. The support seats 14 and the nut unit 13 are drivingly connected by a belt 15 and a wheel 16, so that the support seats 14 can change speed and direction of motion to support the screw 11 and prevent sagging of the screw 11.

When two ends 111, 112 of the screw 11 are used as fixing ends, namely fixed at two rotation fixing members 17 to ensure the concentricity and rotary precision of the screw 11, the diameter proportion between the nut-drive portion 161 of the wheel 16 for moving the nut unit 13 and the support-seat-drive portion 162 of the wheel 16 for moving the support seats 14 is designed to make the proportion of the speed Vₛᵤₚ of the support seats 14 to the speed V_{NT} of the nut unit 13 1:2, which optimizes the critical rotation speed of the ball screw, consequently increasing the displacement speed of the nut unit 13 and the support seats 14, and improving working efficiency.

However, when the two ends 111, 112 of the screw 11 are fused as fixing and supporting ends, respectively, namely, the fixing end of the screw 11 is fixed at the rotation fixing member 17, and the support end of the screw 11 is disposed on a rotation support member 18. At this moment, if the structure is designed to make the proportion of the speed Vₛᵤₚ of the support seats to the speed V_{NT} of the nut 1:2, the critical rotation speed of the ball screw is not an optimum value, and as a result, the displacement speed of the nut unit 13 and the support seats 14 is restricted, and working efficiency cannot be improved efficiently.

The present invention has arisen to mitigate and/or obviate the afore-described disadvantages.

### SUMMARY

The present invention is aimed at providing a ball screw with a support device, when the two ends of the screw are used as a fixing end and a support end, respectively, the ball screw can have an optimized critical rotation speed, which consequently improves the work efficiency of the ball screw.

Therefore, a ball screw with a support device in accordance with one respect of the present invention comprises: a screw; a nut unit movably mounted on the screw; a support device including: a first support seat and a second support seat which are movably mounted on the screw and located at two sides of the nut unit; and a speed control device capable of presetting a speed of the nut unit and the first and second support seats, wherein the speed of the nut unit is V_{NT}, the speed of the first and second support seats is V_{SUP}, and they satisfy the relation: 0<V_{SUP}\V_{NT}<½.

Preferably, the nut unit includes a nut movably mounted on the screw, and a carrying platform fixed on the nut, the speed control device includes: two wheel mounting seats, two wheels, a nut motion transmission member, and a support seat motion transmission member, the two wheel mounting seats are located at two sides of the first and second support seats, the first and second support seats and the nut unit are located between the two wheel mounting seats, the two wheels are mounted on the wheel mounting seats and each include a nut wheel portion and a support wheel portion which has an outer diameter different from an outer diameter of the nut wheel portion, the nut motion transmission member is connected between the nut wheel portions and the nut unit, and the support seat transmission member is connected between the support wheel portions and the first and second support seats, the outer diameter of the nut wheel portions is R_{NT}, the outer diameter of the support wheel portion is R_{SUP}, the wheel mounting seats each has a width C, the carrying platform has a width 2D, the first and second support seats each have a width 2E, a displacement distance of the nut unit is L_{NT}, the nut unit is disposed within the displacement distance L_{NT}, when the carrying platform is at the left or right end of the displacement distance L_{NT}, a safety distance from the first and second support seats to the carrying platform is B, and they satisfy the relation:

$$\frac{{L}_{NT} - 0.25 B - 1.25 C + D - 0.25 E}{2.25 {L}_{NT}} - \frac{1}{2.5} < \frac{{R}_{SUP}}{{R}_{NT}} < \frac{1}{2} .$$

Preferably, the nut motion transmission member and the support seat motion transmission member are belts or steel cords.

Preferably, when the two wheels are belt driven wheels, the nut motion transmission member is belt, and the support seat motion transmission member is belt, a quantity of teeth of the nut wheel portion is Z_{NT}, a quantity of teeth of the support wheel portion is Z_{SUP}, and they satisfy the relation:

$$\frac{{L}_{NT} - 0.25 B - 1.25 C + D - 0.25 E}{2.25 {L}_{NT}} - \frac{1}{2.5} < \frac{{Z}_{SUP}}{{Z}_{NT}} < \frac{1}{2} .$$

Preferably, the screw includes a fixing end and a support end at two ends thereof, the fixing end is disposed at a rotation fixing unit, and the support end is disposed on a rotation support unit.

A ball screw with a support device in accordance with another respect of the present invention comprises: a screw; a nut unit movably mounted on the screw; a support device including a first support seat and a second support seat which are movably mounted on the screw and located at two sides of the nut unit, a third support seat which is movably mounted on the screw and located between the nut unit and the second support seat, and a fourth support seat which is movably mounted on the screw and located between the nut unit and the first support seat, wherein the first and second support seats move at the same speed, and the third and fourth support seats move at the same speed; and a speed control device capable of presetting speeds of the nut unit and the first, second, third and fourth support seats, wherein the speed of the nut unit is V_{NT}, the speed of the first and second support seats is V_{SUP}, the speed of the third and fourth support seats is V_{SUP}, and they satisfy the relations:

$$0 < \frac{{V}_{SUP 2}}{{V}_{NT}} < \frac{1}{3} ; 0 < \frac{{V}_{SUP 2}}{{V}_{SUP 3}} < \frac{1}{2} .$$

Preferably, the nut unit includes a nut movably mounted on the screw, and a carrying platform fixed on the nut, the speed control device includes: two wheel mounting seats, two wheels, a nut motion transmission member, a first support seat motion transmission member, and a second support seat motion transmission member, the two wheel mounting seats are located at two sides of the first and second support seats, the first, second, third and fourth support seats and the nut unit are located between the two wheel mounting seats, the two wheels are mounted on the wheel mounting seats and each include a nut wheel portion, a first support wheel portion, and a second support wheel portion which has an outer diameter different from outer diameters of the nut wheel portion and the first support wheel portion, the nut motion transmission member is connected between the nut wheel portions and the nut unit, the first support seat transmission member is connected between the first support wheel portion and the first and second support seats, and the second support seat transmission member is connected between the second support wheel portion and the third and fourth support seats, an outer diameter of the nut wheel portions is R_{NT}, the outer diameter of the first support wheel portion is R_{SUP}, the outer diameter of the second support wheel portion is R_{SUP}, the wheel mounting seats each has a width C, the carrying platform has a width 2D, the first, second, third and fourth support seats each have a width 2E, a displacement distance of the nut unit is L_{NT}, the nut unit is disposed within the displacement distance L_{NT}, when the carrying platform is at the left or right end of the displacement distance L_{NT}, a safety distance between the first and fourth support seats, between the fourth support seat and the carrying platform, between the second and third support seats, and between the third support seat and the carrying platform is B, and they satisfy the relation:

$$\frac{{L}_{NT} - 0.25 B - 2.25 C + D + 3 E}{3.25 {L}_{NT}} - \frac{1}{3.4} < \frac{{R}_{SUP 2}}{{R}_{NT}} < \frac{1}{3} ;$$

$$\frac{{L}_{NT} - 0.25 B - 2.25 C + D + 3 E}{2 {L}_{NT} - 0.25 B - 1.25 C + 2 D - 0.5 E} - \frac{1}{2.2} < \frac{{R}_{SUP 2}}{{R}_{SUP 3}} < \frac{1}{2}$$

Preferably, the nut motion transmission member, the first support seat motion transmission member and the second support seat motion transmission member are belts or steel cords.

Preferably, the two wheels are belt driven wheels, the nut motion transmission member is belt, the first and second support seat motion transmission member are belts, a quantity of teeth of the nut wheel portion is Z_{NT}, a quantity of teeth of the first support wheel portion is Z_{SUP2}, a quantity of teeth of the second support wheel portion is Z_{SUP3}, and they satisfy the relations:

$$\frac{{L}_{NT} - 0.25 B - 2.25 C + D + 3 E}{3.25 {L}_{NT}} - \frac{1}{3.4} < \frac{{Z}_{SUP 2}}{{Z}_{NT}} < \frac{1}{3}$$

$$\frac{{L}_{NT} - 0.25 B - 2.25 C + D + 3 E}{2 {L}_{NT} - 0.25 B - 1.25 C + 2 D - 0.5 E} - \frac{1}{2.2} < \frac{{Z}_{SUP 2}}{{Z}_{SUP 3}} < \frac{1}{2}$$

Preferably, the screw includes a fixing end and a support end at two ends thereof, the fixing end is disposed at a rotation fixing unit, and the support end is disposed on a rotation support unit.

The speed control device is capable of presetting the speed of the nut unit and the first and second support seats, or presetting the speed of the nut unit and the third and fourth support seats, which optimizes the critical rotation speed of the ball screw and improves the work efficiency of the same.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1A shows a ball screw with a support device disclosed in a German patent No. DE 102009005785A1;

FIG. 1B is a magnified view of a part of FIG. 1A;

FIG. 2 is a top view of a ball screw with a support device in accordance with a first preferred embodiment of the present invention;

FIG. 3 is a perspective view showing a speed control device of the ball screw in accordance with the first preferred embodiment of the present invention;

FIG. 4 is an illustrative view of the ball screw in accordance with the first preferred embodiment of the present invention;

FIG. 5 is another illustrative view of the ball screw in accordance with the first preferred embodiment of the present invention;

FIG. 6 shows the comparison between the critical speed of the ball screw of the first preferred embodiment of the present invention and that of a conventional ball screw;

FIG. 7 shows the comparison between the critical speed of the ball screw of the first preferred embodiment of the present invention and that of a conventional ball screw;

FIG. 8 is an illustrative view of the ball screw in accordance with a second preferred embodiment of the present invention; and

FIG. 9 is another illustrative view of the ball screw in accordance with the second preferred embodiment of the present invention.

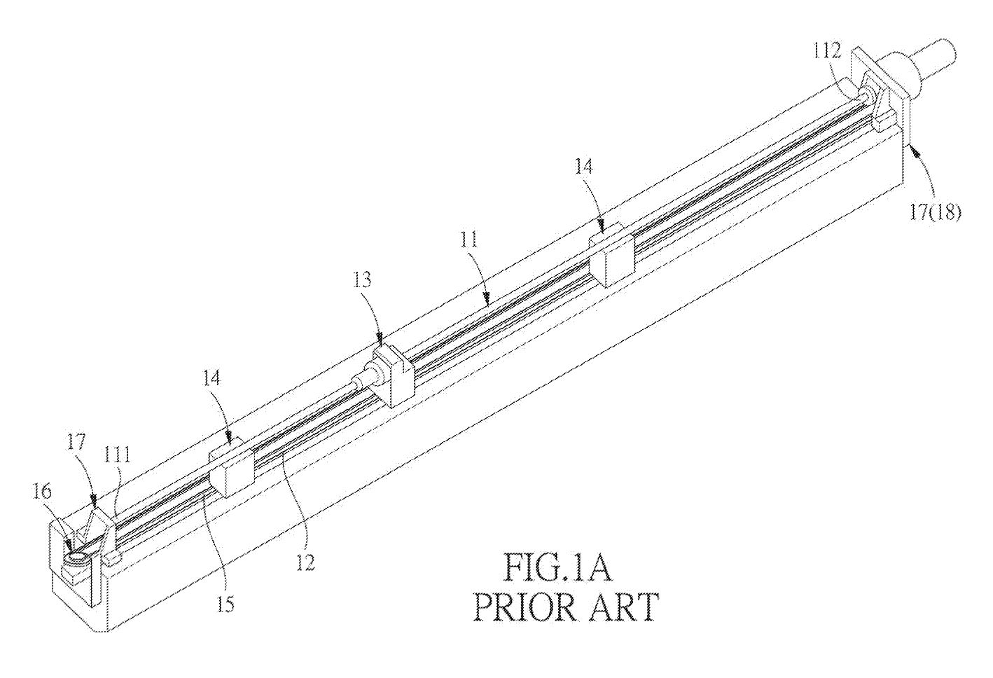

### DETAILED DESCRIPTION

The present invention will be clearer from the following description when viewed together with the accompanying drawings, which show, for purpose of illustrations only, the preferred embodiment in accordance with the present invention.

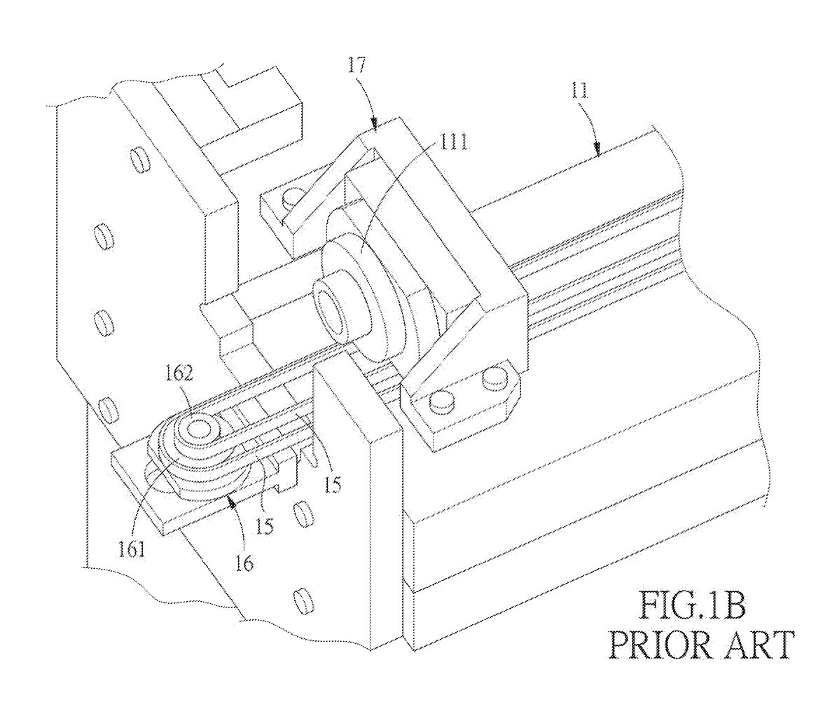

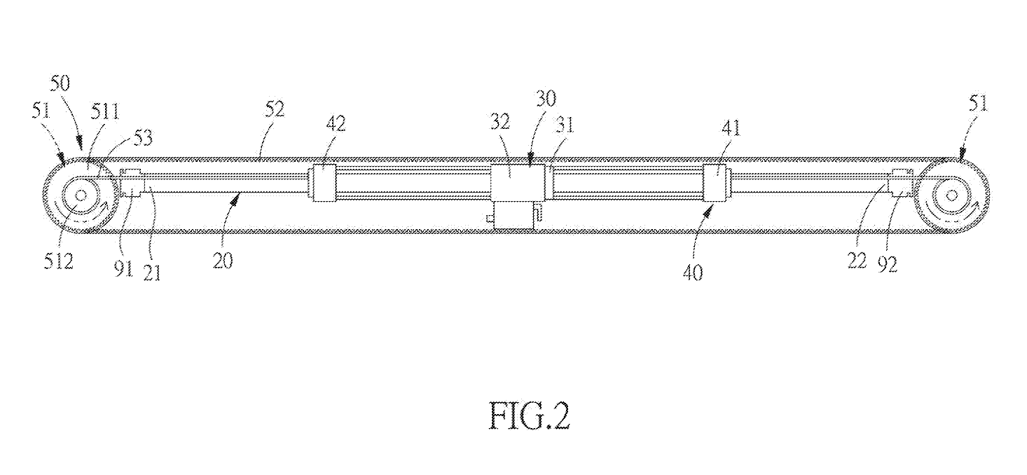

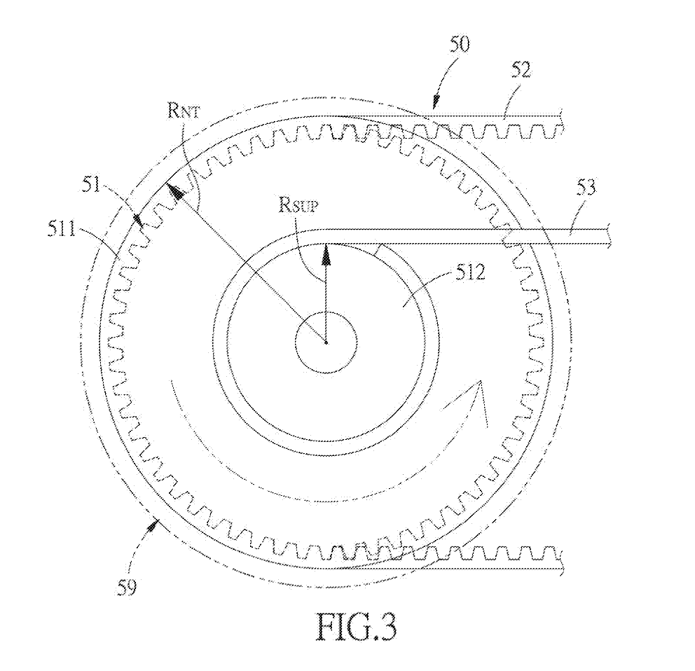

Referring to FIGS. 2-5, a ball screw with a support device 40 in accordance with the first preferred embodiment of the present invention comprises: a screw 20, a nut unit 30, the support device 40 and a speed control device 50.

The screw 20 includes a fixing end 21 and a support end 22 at two ends thereof. The fixing end 21 is disposed at a rotation fixing unit 91, and the support end 22 is disposed on a rotation support unit 92.

The nut unit 30 is movably mounted on the screw 20. In this embodiment, the nut unit 30 includes a nut 31 movably mounted on the screw 20, and a carrying platform 32 fixed on the nut 31.

The support device 40 includes: a first support seat 41 and a second support seat 42 which are movably mounted on the screw 20 and located at two sides of the nut unit 30.

The speed control device 50 is capable of presetting the speed of the nut unit 30 and the first and second support seats 41, 42. Suppose the speed of the nut unit 30 is V_{NT}, the speed of the first and second support seats 41, 42 is V_{SUP}, and they satisfy the relation: 0<V_{SUP}/V_{NT}<½. In this embodiment, the speed control device 50 includes: two wheel mounting seats 59, two wheels 51, a nut motion transmission member 52 in the form of a belt (or steel cord), and a support seat motion transmission member 53 in the form of a belt (or steel cord). The two wheel mounting seats 59 are located at two sides of the first and second support seats 41, 42, in such a manner that the first and second support seats 41, 42 and the nut unit 30 are located between the two wheel mounting seats 59. The two wheels 51 are mounted on the wheel mounting seats 59, and each include a nut wheel portion 511 and a support wheel portion 512 which has an outer diameter different from an outer diameter of the nut wheel portion 511. The nut motion transmission member 52 is connected between the nut wheel portions 511 and the nut unit 30, and the support seat transmission member 53 is connected between the support wheel portions 512 and the first and second support seats 41, 42. The outer diameter of the nut wheel portions 511 is R_{NT}, the outer diameter of the support wheel portion 512 is R_{SUP}, the wheel mounting seats 59 each has a width C, the carrying platform has a width 2D, the first and second support seats 41, 42 each have a width 2E, a displacement distance of the nut unit 30 is L_{NT}, the nut unit 30 is disposed within the displacement distance L_{NT}, when the carrying platform 32 is at the left or right end of the displacement distance L_{NT}, a safety distance from the first and second support seats 41, 42 to the carrying platform 32 is B, and they satisfy the relation:

$$\frac{{L}_{NT} - 0.25 B - 1.25 C + D - 0.25 E}{2.25 {L}_{NT}} - \frac{1}{2.5} < \frac{{R}_{SUP}}{{R}_{NT}} < \frac{1}{2} .$$

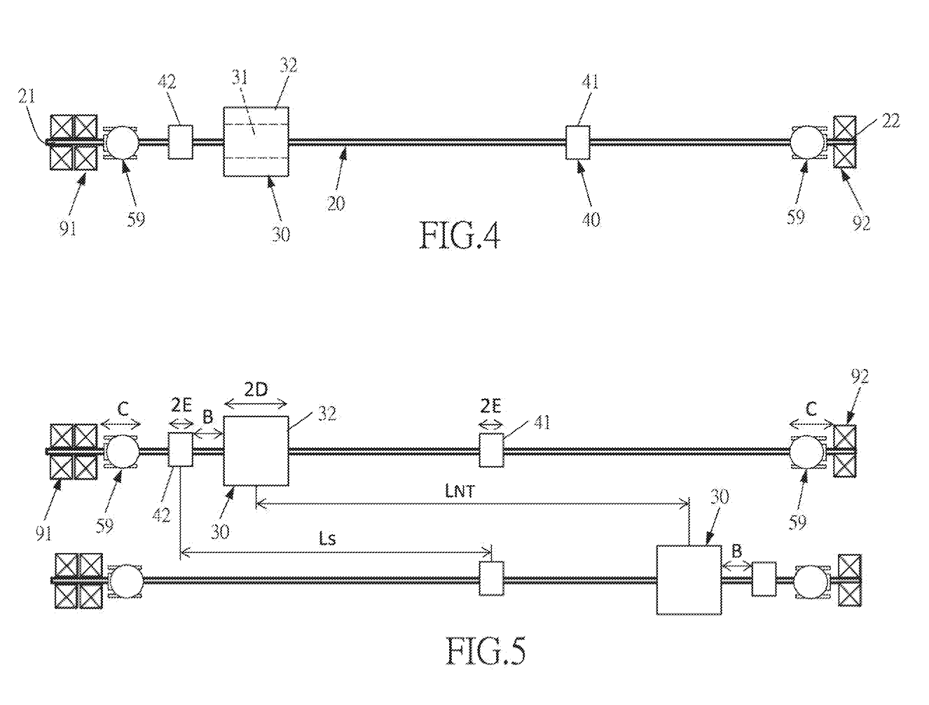

The Lₛ as shown in FIG. 5 is the displacement distance of the first and second support seats 41, 42.

With the abovementioned arrangements, the ball screw can have an optimized critical rotation speed under the condition that the two ends of the screw 20 are used as a fixing end and a support end, respectively, which consequently improves the work efficiency of the ball screw.

The present invention will be clearer from the following numerical example when taken in conjunction with FIG. 5.

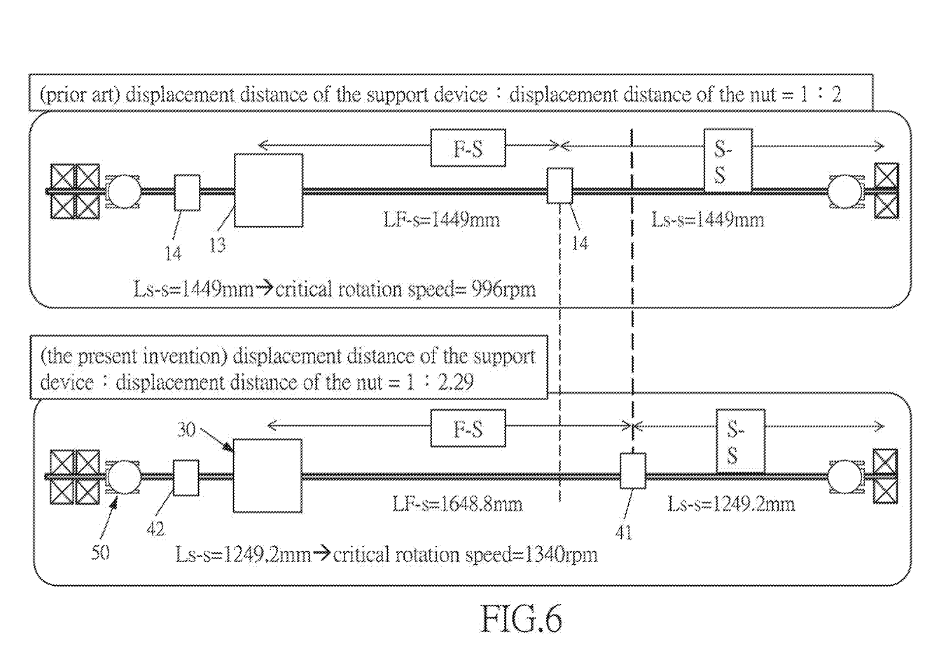

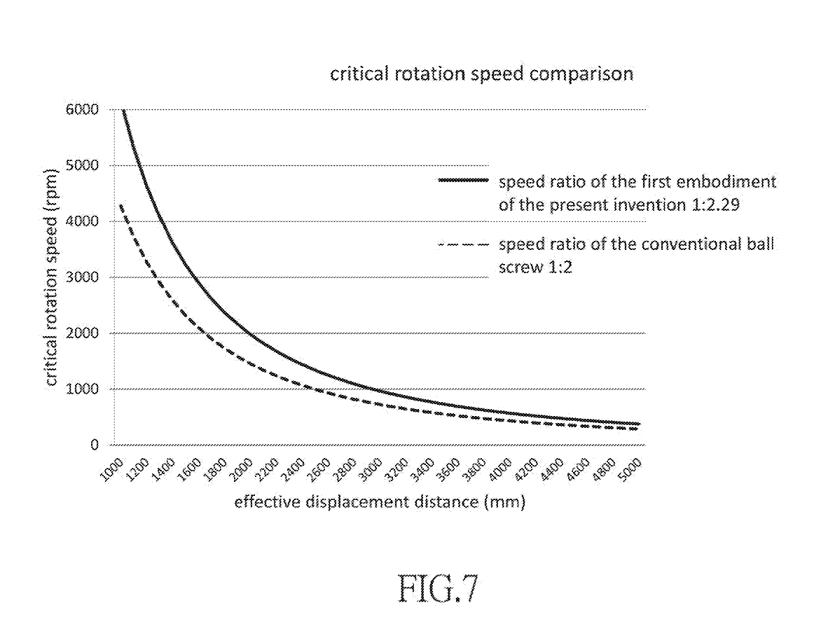

Suppose that the width C of the wheel mounting seats 59 is 105 mm, the width 2D of the carrying platform is 200 mm, the width 2E of the first and second support seats 41, 42 is 85 mm, the displacement distance L_{NT} of the nut unit 30 is 2500 mm, the safety distance B is 10 mm, therefore, the proportion between the outer diameter R_{NT} of the nut wheel portions 511 and the outer diameter R_{SUP} of the support wheel portion 512 will be: R_{SUP}/R_{NT}=(2500−0.25×10−1.25×105+100−0.25×42.5)/(2.25×2500)=1/2.29, and the proportion between the displacement distance L_{S} of the first and second support seats 41, 42 and the displacement distance L_{NT} of the nut unit 30 will be: 1:2.29. Therefore, as shown in FIGS. 6 and 7, the critical speed of the ball screw will be 1340 rpm. However, like it said in the “related prior art”, when the proportion between the displacement distance of the support seats 14 and the displacement distance of the nut unit 13 is 1:2, the critical rotation speed of the conventional ball screw will be 996 rpm. With the speed control device 50 capable of presetting the speed of the nut unit 30 and the first and second support seats 41, 42, and the proportion between the outer diameter R_{NT} of the nut wheel portions 511 and the outer diameter R_{SUP} of the support wheel portion 512, the ball screw of the present invention can have an optimized critical rotation speed, which consequently improves the work efficiency of the ball screw.

Here is another numerical example to illustrate the first embodiment, suppose that the width C of the wheel mounting seats 59 is 80 mm, the width 2D of the carrying platform is 250 mm, the width 2E of the first and second support seats 41, 42 is 100 mm, the displacement distance L_{NT} of the nut unit 30 is 2200 mm, the safety distance B is 15 mm, therefore, the proportion between the outer diameter R_{NT} of the nut wheel portions 511 and the outer diameter R_{SUP} of the support wheel portion 512 will be: R_{SUP}/R_{NT}=(2200−0.25×15−1.25×80+125−0.25×50)/(2.25×2200)=1/2.24. Such arrangements can also optimize the critical rotation speed of the ball screw and improve the work efficiency of the same.

It is to be noted that in the first embodiment, when the two wheels 51 are belt driven wheels, the nut motion transmission member 52 is belt, and the support seat motion transmission member 53 is belt, the number of teeth of the nut wheel portion 511 is Z_{NT}, the number of teeth of the support wheel portion 512 is Z_{SUP}, and they satisfy the relation:

$$\frac{{L}_{NT} - 0.25 B - 1.25 C + D - 0.25 E}{2.25 {L}_{NT}} - \frac{1}{2.5} < \frac{{Z}_{SUP}}{{Z}_{NT}} < \frac{1}{2} .$$

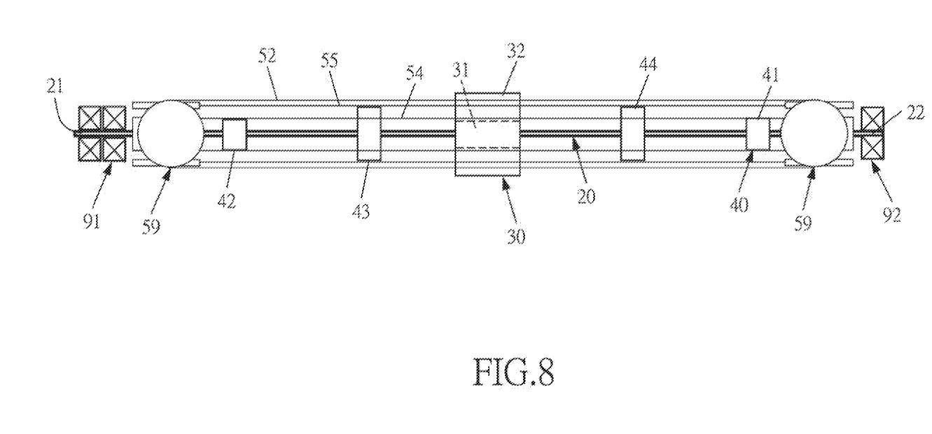

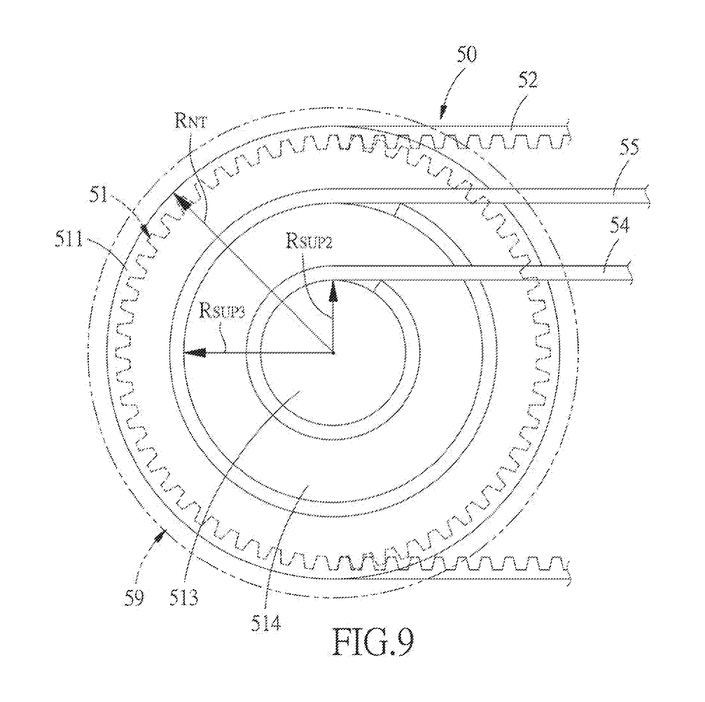

Referring to FIGS. 8 and 9, a ball screw with a support device 40 in accordance with the second preferred embodiment of the present invention comprises: a screw 20, a nut unit 30, the support device 40 and a speed control device 50.

The screw 20 includes a fixing end 21 and a support end 22 at two ends thereof. The fixing end 21 is disposed at a rotation fixing unit 91, and the support end 22 is disposed on a rotation support unit 92.

The nut unit 30 is movably mounted on the screw 20. In this embodiment, the nut unit 30 includes a nut 31 movably mounted on the screw 20, and a carrying platform 32 fixed on the nut 31.

The support device 40 includes: a first support seat 41 and a second support seat 42 which are movably mounted on the screw 20 and located at two sides of the nut unit 30, a third support seat 43 which is movably mounted on the screw 20 and located between the nut unit 30 and the second support seat 42, and a fourth support seat 44 which is movably mounted on the screw 20 and located between the nut unit 30 and the first support seat 41. The first and second support seats 41, 42 move at the same speed, and the third and fourth support seats 43, 44 move at the same speed.

The speed control device 50 is capable of presetting the speeds of the nut unit 30 and the first, second, third and fourth support seats 41, 42, 43, 44. Suppose the speed of the nut unit 30 is V_{NT}, the speed of the first and second support seats 41, 42 is V_{SUP2}, the speed of the third and fourth support seats 43, 44 is V_{SUP3}, and they satisfy the relations:

$$0 < \frac{{V}_{SUP 2}}{{V}_{NT}} < \frac{1}{3} ; 0 < \frac{{V}_{SUP 2}}{{V}_{SUP 3}} < \frac{1}{2} .$$

In this embodiment, the speed control device 50 includes: two wheel mounting seats 59, two wheels 51, a nut motion transmission member 52 in the form of a belt (or steel cord), a first support seat motion transmission member 54 in the form of a belt (or steel cord), and a second support seat motion transmission member 55 in the form of a belt (or steel cord). The two wheel mounting seats 59 are located at two sides of the first and second support seats 41, 42, in such a manner that the first, second, third and fourth support seats 41, 42, 43, 44 and the nut unit 30 are located between the two wheel mounting seats 59. The two wheels 51 are mounted on the wheel mounting seats 59, and each include a nut wheel portion 511, a first support wheel portion 513, and a second support wheel portion 514 which has an outer diameter different from outer diameters of the nut wheel portion 511 and the first support wheel portion 513. The nut motion transmission member 52 is connected between the nut wheel portions 511 and the nut unit 30, the first support seat transmission member 54 is connected between the first support wheel portion 513 and the first and second support seats 41, 42, and the second support seat transmission member 55 is connected between the second support wheel portion 514 and the third and fourth support seats 43, 44.
The outer diameter of the nut wheel portions 511 is R_{NT}, the outer diameter of the first support wheel portion 513 is R_{SUP2}, the outer diameter of the second support wheel portion 514 is R_{SUP3}, the wheel mounting seats 59 each has a width C, the carrying platform has a width 2D, the first, second, third and fourth support seats 41, 42, 43 and 44 each have a width 2E, a displacement distance of the nut unit 30 is L_{NT}, the nut unit 30 is disposed within the displacement distance L_{NT}, when the carrying platform 32 is at the left or right end of the displacement distance L_{NT}, a safety distance between the first and fourth support seats 41, 44, between the fourth support seat 44 and the carrying platform 32, between the second and third support seats 432, 43, and between the third support seat 43 and the carrying platform 32 is B, and they satisfy the relation:

$$\frac{{L}_{NT} - 0.25 B - 2.25 C + D + 3 E}{3.25 {L}_{NT}} - \frac{1}{3.4} < \frac{{R}_{SUP 2}}{{R}_{NT}} < \frac{1}{3}$$

$$\frac{{L}_{NT} - 0.25 B - 2.25 C + D + 3 E}{2 {L}_{NT} - 0.25 B - 1.25 C + 2 D - 0.5 E} - \frac{1}{2.2} < \frac{{R}_{SUP 2}}{{R}_{SUP 3}} < \frac{1}{2}$$

With the abovementioned arrangements, the ball screw can have an optimized critical rotation speed under the condition that the two ends of the screw 20 are used as a fixing end and a support end, respectively, which consequently improves the work efficiency of the ball screw.

The second embodiment will be clearer from the following numerical example.

Suppose that the width C of the wheel mounting seats 59 is 80 mm, the width 2D of the carrying platform is 250 mm, the width 2E of the first and second support seats 41, 42 is 100 mm, the displacement distance L_{NT} of the nut unit 30 is 2200 mm, the safety distance B is 15 mm, therefore, the proportion between the outer diameter R_{NT} of the nut wheel portions 511 and the outer diameter R_{SUP2} of the first support wheel portion 513 will be: R_{SUP2}/R_{NT}=(2200−0.25×15−2.25×80+125+3×50)/(3.25×2200)=1/3.12, and the proportion between the displacement distance L_{S} of the first and second support seats 41, 42 and the displacement distance L_{NT} of the nut unit 30 will also be: 1:3.12. the proportion between the outer diameter R_{SUP2} of the first support wheel portion 513 and the outer diameter R_{SUP3} of the second support wheel portion 514 will be: R_{SUP2}/R_{SUP3}=(2200−0.25×15−2.25×80+125+3×50)/(2×2200−0.25×15+1.25×80+2×125−0.5×50)=1/2.06, and the proportion between the displacement distance L_{S} of the third and fourth support seats 43, 44 and the displacement distance L_{NT} of the nut unit 30 will also be: 1:2.06.

It is to be noted that in the second embodiment, when the two wheels 51 are belt driven wheels, the nut motion transmission member 52 is belt, the first and second support seat motion transmission member 54, 55 are belts, the number of teeth of the nut wheel portion 511 is Z_{NT}, the number of teeth of the first support wheel portion 513 is Z_{SUP2}, the number of teeth of the second support wheel portion 514 is Z_{SUP3}, and they satisfy the relations:

$$\frac{{L}_{NT} - 0.25 B - 2.25 C + D + 3 E}{3.25 {L}_{NT}} - \frac{1}{3.4} < \frac{{Z}_{SUP 2}}{{Z}_{NT}} < \frac{1}{3}$$

$$\frac{{L}_{NT} - 0.25 B - 2.25 C + D + 3 E}{2 {L}_{NT} - 0.25 B - 1.25 C + 2 D - 0.5 E} - \frac{1}{2.2} < \frac{{Z}_{SUP 2}}{{Z}_{SUP 3}} < \frac{1}{2}$$

While we have shown and described various embodiments in accordance with the present invention, it is clear to those skilled in the art that further embodiments may be made without departing from the scope of the present invention.

1. A ball screw with a support device, comprising:
a screw;
a nut unit movably mounted on the screw;
a support device including: a first support seat and a second support seat which are movably mounted on the screw and located at two sides of the nut unit; and
a speed control device capable of presetting a speed of the nut unit and the first and second support seats, wherein the speed of the nut unit is V_{NT}, the speed of the first and second support seats is V_{SUP}, and they satisfy the relation:
0<V_{SUP}/V_{NT}<½.

2. The ball screw with the support device as claimed in claim 1, wherein the nut unit includes a nut movably mounted on the screw, and a carrying platform fixed on the nut, the speed control device includes: two wheel mounting seats, two wheels, a nut motion transmission member, and a support seat motion transmission member, the two wheel mounting seats are located at two sides of the first and second support seats, the first and second support seats and the nut unit are located between the two wheel mounting seats, the two wheels are mounted on the wheel mounting seats and each include a nut wheel portion and a support wheel portion which has an outer diameter different from an outer diameter of the nut wheel portion, the nut motion transmission member is connected between the nut wheel portions and the nut unit, and the support seat transmission member is connected between the support wheel portions and the first and second support seats, the outer diameter of the nut wheel portions is R_{NT}, the outer diameter of the support wheel portion is Rₛᵤp, the wheel mounting seats each has a width C, the carrying platform has a width 2D, the first and second support seats each have a width 2E, a displacement distance of the nut unit is L_{NT}, the nut unit is disposed within the displacement distance L_{NT}, when the carrying platform is at the left or right end of the displacement distance L_{NT}, a safety distance from the first and second support seats to the carrying platform is B, and they satisfy the relation:
$$\frac{{L}_{NT} - 0.25 B - 1.25 C + D - 0.25 E}{2.25 {L}_{NT}} - \frac{1}{2.5} < \frac{{R}_{SUP}}{{R}_{NT}} < \frac{1}{2} .$$

3. The ball screw with the support device as claimed in claim 2, wherein the nut motion transmission member and the support seat motion transmission member are belts or steel cords.

4. The ball screw with the support device as claimed in claim 2, wherein when the two wheels are belt driven wheels, the nut motion transmission member is belt, and the support seat motion transmission member is belt, a quantity of teeth of the nut wheel portion is Z_{NT}, a quantity of teeth of the support wheel portion is Z_{SUP}, and they satisfy the relation:
$$\frac{{L}_{NT} - 0.25 B - 1.25 C + D - 0.25 E}{2.25 {L}_{NT}} - \frac{1}{2.5} < \frac{{Z}_{SUP}}{{Z}_{NT}} < \frac{1}{2} .$$

5. The ball screw with the support device as claimed in claim 1, wherein the screw includes a fixing end and a support end at two ends thereof, the fixing end is disposed at a rotation fixing unit, and the support end is disposed on a rotation support unit.

6. The ball screw with the support device as claimed in claim 2, wherein the screw includes a fixing end and a support end at two ends thereof, the fixing end is disposed at a rotation fixing unit, and the support end is disposed on a rotation support unit.

7. A ball screw with a support device, comprising:
a screw;
a nut unit movably mounted on the screw;
a support device including a first support seat and a second support seat which are movably mounted on the screw and located at two sides of the nut unit, a third support seat which is movably mounted on the screw and located between the nut unit and the second support seat, and a fourth support seat which is movably mounted on the screw and located between the nut unit and the first support seat, wherein the first and second support seats move at the same speed, and the third and fourth support seats move at the same speed; and
a speed control device capable of presetting speeds of the nut unit and the first, second, third and fourth support seats, wherein the speed of the nut unit is V_{NT}, the speed of the first and second support seats is V_{SUP2}, the speed of the third and fourth support seats is V_{SUP3}, and they satisfy the relations:
$$0 < \frac{{V}_{SUP 2}}{{V}_{NT}} < \frac{1}{3} ; 0 < \frac{{V}_{SUP 2}}{{V}_{SUP 3}} < \frac{1}{2} .$$

8. The ball screw with the support device as claimed in claim 7, wherein the nut unit includes a nut movably mounted on the screw, and a carrying platform fixed on the nut, the speed control device includes: two wheel mounting seats, two wheels, a nut motion transmission member, a first support seat motion transmission member, and a second support seat motion transmission member, the two wheel mounting seats are located at two sides of the first and second support seats, the first, second, third and fourth support seats and the nut unit are located between the two wheel mounting seats, the two wheels are mounted on the wheel mounting seats and each include a nut wheel portion, a first support wheel portion, and a second support wheel portion which has an outer diameter different from outer diameters of the nut wheel portion and the first support wheel portion, the nut motion transmission member is connected between the nut wheel portions and the nut unit, the first support seat transmission member is connected between the first support wheel portion and the first and second support seats, and the second support seat transmission member is connected between the second support wheel portion and the third and fourth support seats, an outer diameter of the nut wheel portions is R_{NT}, the outer diameter of the first support wheel portion is R_{SUP2}, the outer diameter of the second support wheel portion is R_{SUP3}, the wheel mounting seats each has a width C, the carrying platform has a width 2D, the first, second, third and fourth support seats each have a width 2E, a displacement distance of the nut unit is L_{NT}, the nut unit is disposed within the displacement distance L_{NT}, when the carrying platform is at the left or right end of the displacement distance L_{NT}, a safety distance between the first and fourth support seats, between the fourth support seat and the carrying platform, between the second and third support seats, and between the third support seat and the carrying platform is B, and they satisfy the relation:
$$\frac{{L}_{NT} - 0.25 B - 2.25 C + D + 3 E}{3.25 {L}_{NT}} - \frac{1}{3.4} < \frac{{R}_{SUP 2}}{{R}_{NT}} < \frac{1}{3}$$
$$\frac{{L}_{NT} - 0.25 B - 2.25 C + D + 3 E}{2 {L}_{NT} - 0.25 B - 1.25 C + 2 D - 0.5 E} - \frac{1}{2.2} < \frac{{R}_{SUP 2}}{{R}_{SUP 3}} < \frac{1}{2} .$$

9. The ball screw with the support device as claimed in claim 7, wherein the nut motion transmission member, the first support seat motion transmission member and the second support seat motion transmission member are belts or steel cords.

10. The ball screw with the support device as claimed in claim 7, wherein the two wheels are belt driven wheels, the nut motion transmission member is belt, the first and second support seat motion transmission member are belts, a quantity of teeth of the nut wheel portion is Z_{NT}, a quantity of teeth of the first support wheel portion is Z_{SUP2}, a quantity of teeth of the second support wheel portion is Z_{SUP3}, and they satisfy the relations:
$$\frac{{L}_{NT} - 0.25 B - 2.25 C + D + 3 E}{3.25 {L}_{NT}} - \frac{1}{3.4} < \frac{{Z}_{SUP 2}}{{Z}_{NT}} < \frac{1}{3}$$
$$\frac{{L}_{NT} - 0.25 B - 2.25 C + D + 3 E}{2 {L}_{NT} - 0.25 B - 1.25 C + 2 D - 0.5 E} - \frac{1}{2.2} < \frac{{Z}_{SUP 2}}{{Z}_{SUP 3}} < \frac{1}{2} .$$

11. The ball screw with the support device as claimed in claim 7, wherein the screw includes a fixing end and a support end at two ends thereof, the fixing end is disposed at a rotation fixing unit, and the support end is disposed on a rotation support unit.

12. The ball screw with the support device as claimed in claim 8, wherein the screw includes a fixing end and a support end at two ends thereof, the fixing end is disposed at a rotation fixing unit, and the support end is disposed on a rotation support unit.
